(19) United States
(12) Patent Application Publication
(10) Pub. No.: US 2005/0289304 A1
(43) Pub. Date: Dec. 29, 2005

(54) Control chip and method thereof and computer system utilizing the same

(75) Inventor: Bi-Yun Yeh, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/077,842

(22) Filed: Mar. 11, 2005

(30) Foreign Application Priority Data
Jun. 23, 2004 (TW) 93118048

(51) Int. Cl. G06F 12/00

(52) U.S. Cl. 711/154

(57) ABSTRACT

A control chip for controlling and accessing an external memory module. The control chip comprises a terminal module and a decision unit. The terminal module is coupled to the external memory module through a memory bus for selectively matching the impedance of the memory bus. The decision unit is coupled to the terminal module and determines whether to turn on the terminal module according to a terminal signal, a dynamic select signal, and a read signal.

### BACKGROUND

The present invention relates to a control chip, and more particularly to a control chip having a dynamic on die terminator (ODT) function.

FIG. 1 is a block diagram of a computer system 100 comprising a system chip and a data path chip commonly referred to as North Bridge chip 12 and South Bridge chip 13, respectively. The term “Bridge” comes from a reference to a device that connects multiple buses.

North Bridge 12 acts as the connection point for CPU 11, memory module 14, graphics controller 15 and South Bridge 13 selectively connecting CPU bus 122 to a memory bus 124, an AGP graphics bus 126, and/or a dedicated interconnection 128 for the South Bridge chip 130.

The South Bridge 13, simply speaking, integrates various I/O controllers, provides interfaces to peripheral devices and buses, and transfers data to/from the North Bridge 12 through the dedicated interconnection 128. For example, South Bridge 13 provides integrated device electronics (IDE) 17 and universal serial bus (USB) 18 interfaces. The basic input-output system (BIOS) may be directly connected to the South Bridge 130.

The following description discloses a transmission method between North Bridge 12 and memory module 14. FIG. 2 is a schematic diagram of a conventional connection of a North Bridge chip and a memory module, where the memory bus 124 transmits data signals therebetween through data lines D₁˜Dₙ.

When the memory module 14 transmits data signals to the North Bridge chip 12 via the memory bus 124, signal reflection may occur in the data lines D₁˜Dₙ due to an impedance mismatch between input ports and the corresponding traces of the data lines D₁˜Dₙ.

If signal reflection occurs, the North Bridge chip 12 cannot know what data is on the data lines until the reflected signal is dispersed and the logic level of the data signal is stable enough for signal recognition. Thus, the access time for the data on the data lines D₁˜Dₙ must be sufficient, otherwise subsequent data signals may be influenced or disturbed such that incorrect data may be received.

To reduce signal reflection, it is proposed that a terminal module 28 be connected at the far end of the memory bus 124. The terminal module 28 comprises terminal units T₁˜Tₙ coupled to the data lines D₁˜Dₙ, respectively, for matching the impedance of the data lines D₁˜Dₙ. In order to rapidly determine the logic levels of the data signals, the default voltage levels on the data lines D₁˜Dₙ, are set to be a fixed reference voltage set by the terminal units T₁˜Tₙ.

Therefore, when the memory module 14 transmits data signals to the North Bridge chip 12, the ends of data lines D₁˜Dₙ near the North Bridge chip 12 preferably have terminal units T₁˜Tₙ, respectively, for reducing reflection occurring on the data lines D₁˜Dₙ. Similarly, when the North Bridge chip 12 transmits data signals to the memory module 14, it is preferable to have other terminal units at the ends of data lines D₁˜Dₙ near the memory module 14.

### SUMMARY

The invention provides a control chip controlling and accessing an external memory module. The control chip comprises a terminal module and a decision unit. The terminal module is coupled to the external memory module through a memory bus for selectively matching the impedance of the memory bus. The decision unit is coupled to the terminal module and determines whether to turn on the terminal module according a terminal signal, a dynamic select signal, and a read signal.

The invention also provides a method for controlling a terminal module to match an impedance of a memory bus. First, a terminal signal, a dynamic select signal, and a read signal are received. Then, the terminal module is enabled according to the terminal signal, the dynamic select signal and the read signal.

The invention also provides a computer system comprising a CPU, an external memory module, a basic input output system (BIOS), and a control chip. The BIOS provides a terminal signal and a dynamic select signal. The control chip is coupled between the CPU and the external memory module. The control chip receives the order of the CPU, accesses the external memory module through a memory bus, and comprises a terminal module selectively enabled according the terminal signal, the dynamic select signal, and a read signal.

### BRIEF DESCRIPTION OF THE DRAWINGS

The invention can be more fully understood by reading the subsequent detailed description and examples with reference made to the accompanying drawings, wherein:

FIG. 1 is a block diagram of a computer system 100;

FIG. 2 is a schematic diagram of a conventional connection of a North Bridge chip and a memory module;

FIG. 3 is a schematic diagram of a chip;

FIG. 4 is a schematic diagram of the North Bridge chip according to an embodiment of the invention;

FIG. 5 is a truth table of the decision unit according to an embodiment of the invention;

FIG. 6 is a schematic diagram of the decision unit according to an embodiment of the invention.

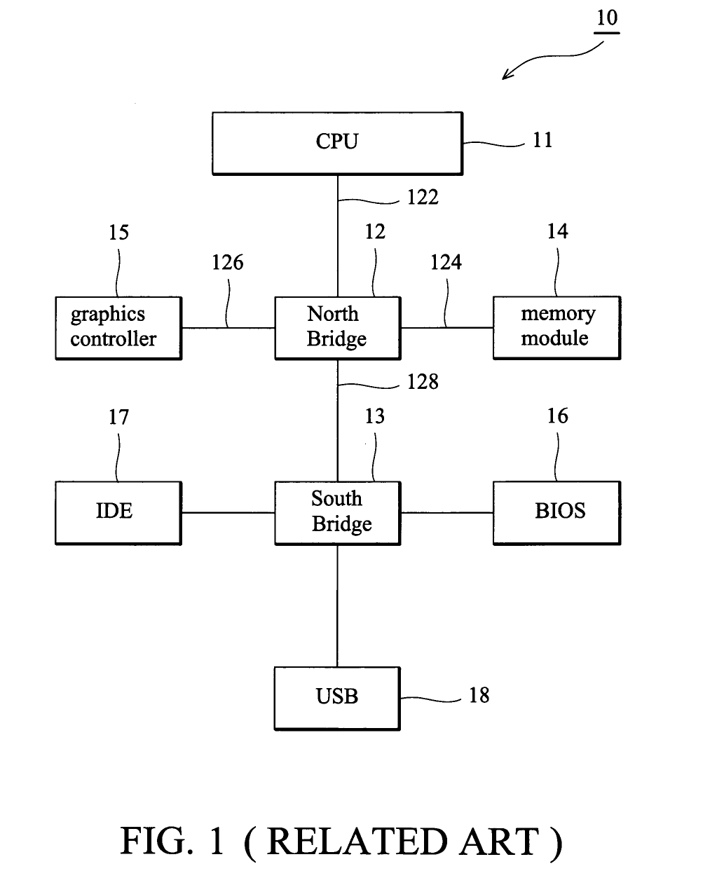

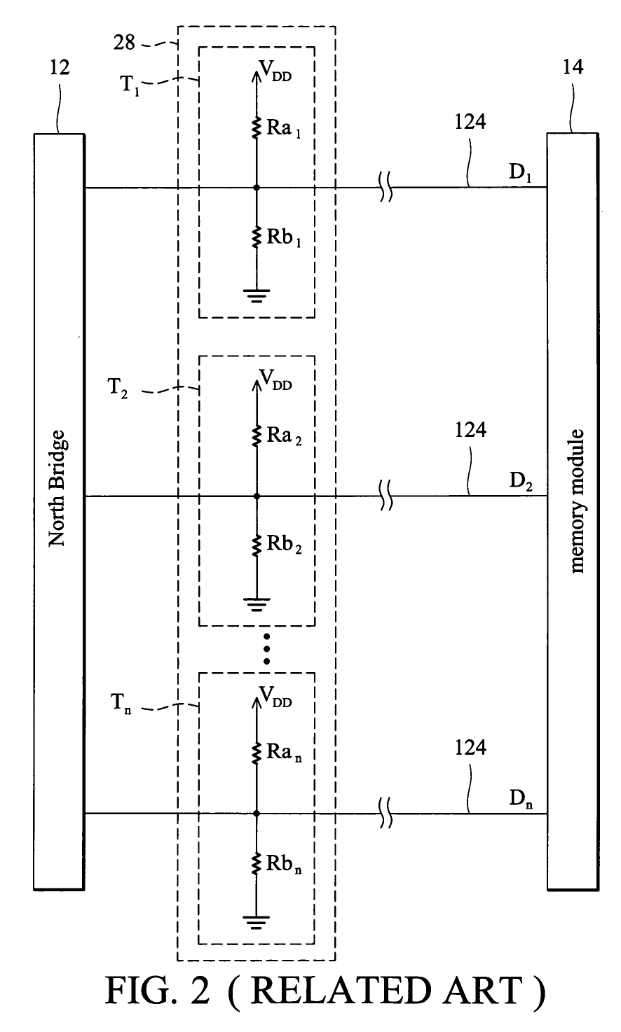

### DETAILED DESCRIPTION

General computer systems comprise a great number of transmission lines. If both ends of each transmission line have external terminal units, each of which is an independently fabricated component, cost of the computer system is increased and available internal capacity on the motherboard of the computer is reduced.

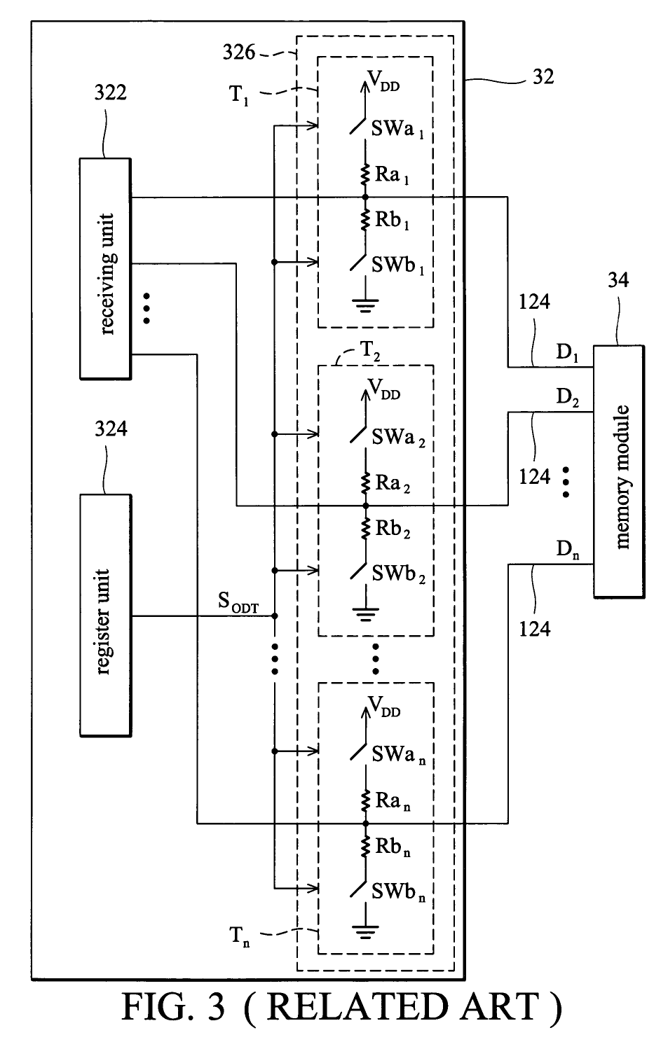

An on die terminator (ODT) has been proposed for integrating selectable terminal units into a chip. FIG. 3 is a schematic diagram of a chip with ODT. Generally, the ODT function is one of the selectable settings in a basic input output system (BIOS). Taking a North Bridge chip as an example, a terminal module 326 inside the North Bridge chip 32 has terminal units T₁˜Tₙ for selectively matching the impedance of the data lines D₁˜Dₙ. Users can determine whether to turn on the ODT function via a BIOS setting of a register unit 324 through a South Bridge chip.

When the ODT function is disabled, terminal signal S_{ODT} stored in the register unit 324 is deasserted to turn off the switches SWa₁˜SWaₙ`SWb₁˜SWbₙ inside terminal units T₁˜Tₙ. When a user desires to turn on the ODT function, by setting a basic input output system (BIOS), the terminal signal S_{ODT} is asserted to turn on the switches SWa₁˜SWaₙ`SWb₁˜SWbₙ. Thus, resistors Ra₁˜Raₙ`Rb₁˜Rbₙ inside the terminal units T₁˜Tₙ set the voltage levels of the data lines D₁˜Dₙ to a default value and also provide impedance matching for each data line. Impedance matching provided by terminal units T₁˜Tₙ, receiving unit 322 can vapidly recognize and receive the data signals output from the memory module 34.

While the ODT function is enabled, the switches SWa₁˜SWaₙ`SWb₁˜SWbₙ are continuously turned on, causing additional current to flow through resistors Ra₁˜Raₙ`Rb₁˜Rbₙ. The additional heat generated by the resistors Ra₁˜Raₙ`Rb₁˜Rbₙ inevitably raises the temperature of the North Bridge chip 32, negatively affecting the operation of the North Bridge chip.

An embodiment of the invention provides a chip with a dynamic ODT function. When the chip is in a read cycle, the dynamic ODT can be enabled. When the chip is not in a read cycle, the dynamic ODT function can be disabled. The chip utilizing the dynamic ODT function can reduce power wasted due to driving the ODT function. Therefore, the temperature of the chip can be reduced.

An embodiment of the invention can be applied to any chip having an ODT function. The chip may be a North Bridge chip, a South Bridge chip, or a memory module.

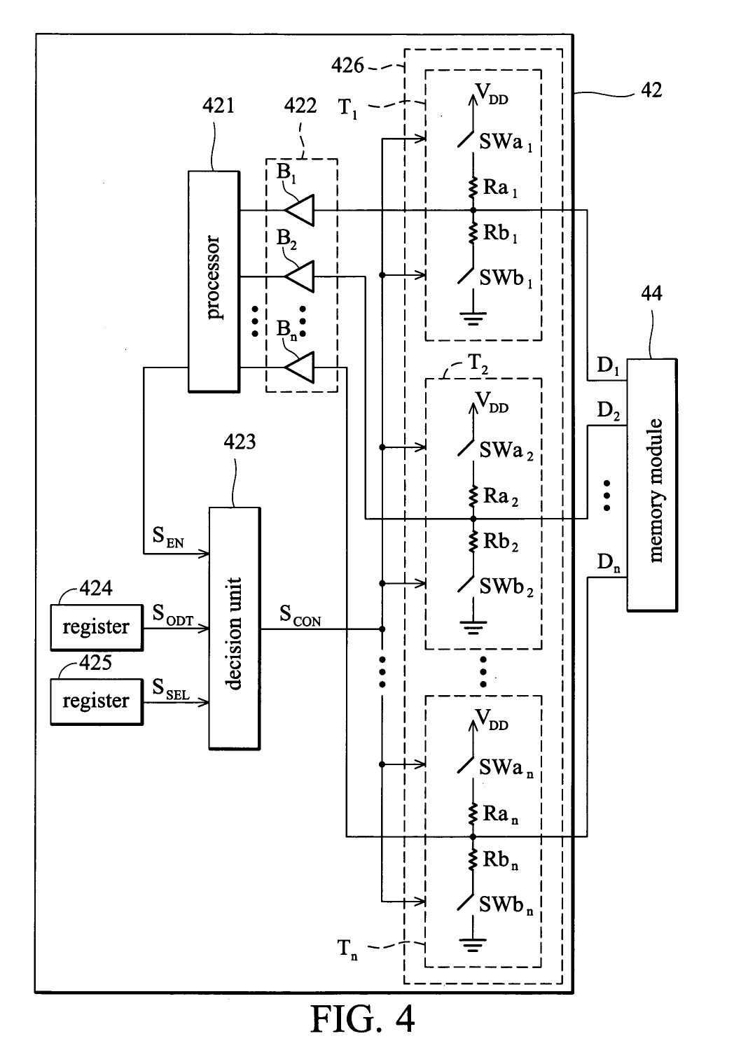

FIG. 4 is a schematic diagram of a North Bridge chip according to an embodiment of the invention. The North Bridge chip 42 comprises a processor 421, a receiver 422, a decision unit 423, registers 424 and 425, and a terminal module 426.

The terminal module 426 has terminal units T₁˜Tₙ to selectively provide impedance matching for data lines D₁˜Dₙ. The receiver 422 comprises buffers B₁˜Bₙ coupled to data lines D₁˜Dₙ, respectively. The processor 421 receives data signals on the data lines D₁˜Dₙ through the receiver 422.

The processor 421 asserts a read signal S_{EN} in a read cycle when the North Bridge chip 42 desires to read data signals outputted from the memory module 44. When the North Bridge chip 42 does not desire to read data signals, the read signal S_{EN} is deasserted. The memory module 44 is dynamic random access memory (DRAM) or double data rate dynamic random access memory (DDR DRAM).

A user can utilize BIOS to set the ODT and dynamic ODT functions. Via the South Bridge chip, the BIOS sets registers 424 and 425 inside the North Bridge chip 42. The register 424 stores a terminal signal S_{ODT}. The register 425 stores a dynamic select signal S_{SEL}.

The decision unit 423 dynamically controls switches SWa₁˜SWaₙ and SWb₁˜SWbₙ according to the terminal signal S_{ODT}, the dynamic select signal S_{SEL}, and the read signal S_{EN}. The BIOS asserts the terminal signal S_{ODT} stored in the register 424 while the ODT function is enabled. The terminal signal S_{ODT} stored in the register 424 is deasserted while the ODT function is disabled. The BIOS asserts the dynamic select signal S_{SEL} stored in the register 425 while the dynamic ODT function is enabled. The dynamic select signal S_{SEL} stored in the register 425 is deasserted while the dynamic ODT function is disabled.

FIG. 5 is a truth table of the decision unit according to an embodiment of the invention, where “0” represents that a corresponding signal is deasserted, “1” represents that a corresponding signal is asserted, and “X” represents that a corresponding signal is “don't care”. As shown in the first row of FIG. 5 with reference to FIG. 4, when the ODT function is disabled, the terminal signal S_{ODT} is deasserted and despite the statuses of the read signal S_{EN} and the dynamic select signal S_{SEL}, a control signal S_{CON} output from the decision unit 423 is deasserted to turn off switches SWa₁˜SWaₙ and SWb₁˜SWbₙ.

As shown in the second row of FIG. 5, when the ODT function is enabled and the dynamic ODT function is disabled, the terminal signal S_{ODT} is asserted and the dynamic select signal S_{SEL} is deasserted. Therefore, the control signal S_{CON} is asserted to continuously turn on switches SWa₁˜SWaₙ and SWb₁˜SWbₙ.

If the ODT and dynamic ODT functions are both enabled, the terminal signal S_{ODT} and the dynamic select signal S_{SEL} are asserted. As shown in the third row of FIG. 5, if the North Bridge chip 42 is not in the read cycle (such as in a write cycle), the read signal S_{EN} is deasserted and the control signal S_{CON} is deasserted accordingly.

In the fourth row of FIG. 5, if the North Bridge chip 42 is in the read cycle, the read signal S_{EN} is asserted. Thus, the control signal S_{CON} is asserted to provide an impedance match.

Accordingly, when the dynamic ODT function is enabled, the ODT function of the North Bridge chip is only enabled in the read cycle. If the North Bridge chip is not in the read cycle, the ODT function is disabled to reduce power consumption.

To test and verify the ODT function, when the read signal S_{EN}, the terminal signal S_{ODT}, and the dynamic select signal S_{SEL} on the same North Bridge chip are controlled, temperature performance of the North Bridge chip can be observed. Temperature of the North Bridge chip is approximately 49.75° C. when the ODT function is disabled. The temperature of the North Bridge chip is approximately 61.21° C. when the ODT function is enabled and the dynamic ODT function is disabled. The temperature of the North Bridge chip is approximately 49.94° C. when the ODT and dynamic functions are enabled.

When the ODT function is set from disable to enable, the temperature of the same North Bridge chip is increased from 49.75° C. to 61.21° C. If the dynamic ODT function is enabled, temperature of the North Bridge chip is only increased by 0.2° C.

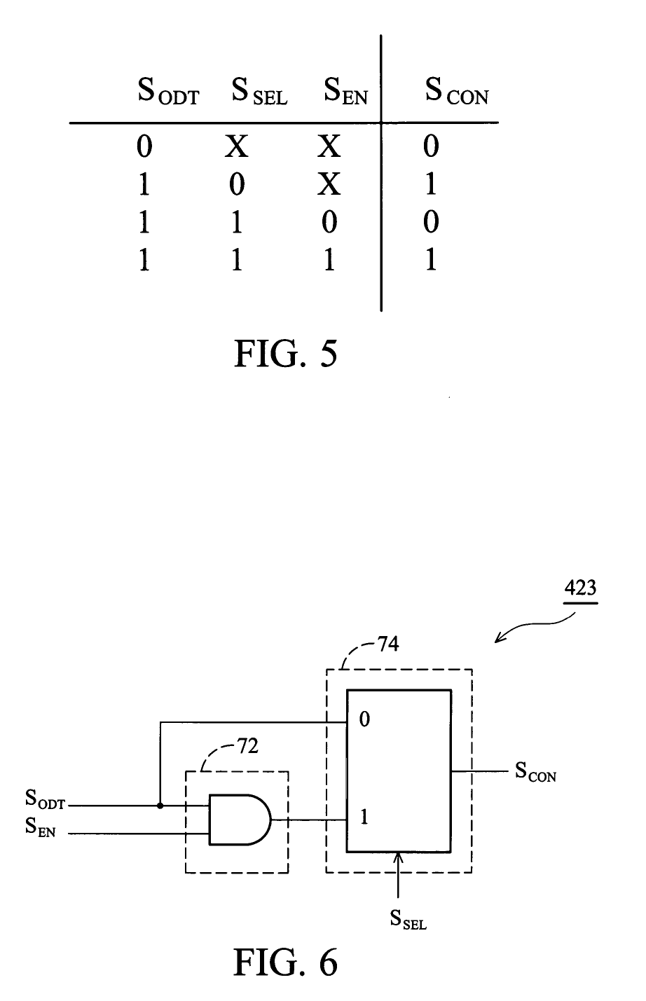

FIG. 6 is a schematic diagram of the decision unit according to an embodiment of the invention. The decision unit 423 comprises a logic unit 72 and a judgment unit 74. The logic unit 72 asserts the control signal S_{CON} only when then terminal signal S_{ODT} and the read signal S_{EN} are asserted. The control signal S_{CON} is deasserted when the terminal signal S_{ODT} or the read signal S_{EN} is deasserted. In this embodiment, the logic unit 72 is a AND gate.

The judgment unit 74 receives the terminal signal S_{ODT}, the dynamic select signal S_{SEL}, and the control signal S_{CON}. When the dynamic select signal S_{SEL} is deasserted, the judgment unit 74 outputs the terminal signal S_{ODT} to the terminal module 426. When the dynamic select signal S_{SEL} is asserted, the judgment unit 74 outputs the control signal S_{CON}. In this embodiment, the judgment unit 74 is a multiplexer.

In summary, the invention has the following advantages. First, since the invention utilizes a terminal module inside a chip for selectively matching impedance of transmittal lines, signal reflection can be greatly reduced. Second, since a chip of the invention has a dynamic ODT function, temperature of the chip is reduced in comparison with the temperature of a chip without a dynamic ODT function.

While the invention has been described by way of example and in terms of the preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A control chip for controlling and accessing an external memory module, the control chip comprising:
a terminal module coupled to the external memory module through a memory bus for selectively matching the impedance of the memory bus; and
a decision unit coupled to the terminal module, wherein the decision unit determines whether to turn on the terminal module according to a terminal signal, a dynamic select signal, and a read signal.

2. The control chip as claimed in claim 1, wherein the decision unit determines whether to turn on the terminal module according the read signal when the terminal signal and the dynamic select signal are asserted.

3. The control chip as claimed in claim 2, wherein the terminal module is enabled when the external memory module is in a read cycle and the read signal is asserted accordingly.

4. The control chip as claimed in claim 2, wherein the terminal module is disabled when the external memory module is not in a read cycle and the read signal is deasserted.

5. The control chip as claimed in claim 1, wherein the terminal module is enabled when the terminal signal is asserted and the dynamic select signal is deasserted.

6. The control chip as claimed in claim 1, wherein the terminal module is disabled when the terminal signal is deasserted.

7. The control chip as claimed in claim 1, further comprising a first register for storing the terminal signal and a second register for storing the dynamic select signal.

8. The control chip as claimed in claim 1, further comprising a processor coupled between the terminal module and the decision unit for providing the read signal.

9. The control chip as claimed in claim 1, wherein the decision unit comprising:
a logic unit outputting an output signal according to the logic levels of the terminal signal and the read signal; and
a judgment unit determining whether to turn on the terminal module according to the logic levels of the output signal and the dynamic select signal.

10. The control chip as claimed in claim 9, wherein the logic unit is AND gate.

11. The control chip as claimed in claim 9, wherein the judgment unit is a multiplexer.

12. The control chip as claimed in claim 1, wherein the external memory module is a dynamic random access memory (DRAM) or double data rate DRAM (DDR DRAM).

13. The control chip as claimed in claim 1, wherein the control chip is North Bridge chip.

14. The control chip as claimed in claim 1, wherein the terminal signal and the dynamic select signal are provided by a basic input output system (BIOS).

15. A computer system, comprising:
a CPU;
an external memory module;
a basic input output system (BIOS) providing a terminal signal and a dynamic select signal; and
a control chip coupled between the CPU and the external memory module, receiving the order of the CPU, and accessing the external memory module through a memory bus, wherein the control chip comprises a terminal module selectively enabled according to the terminal signal, the dynamic select signal, and a read signal.

16. The computer system as claimed in claim 15, wherein the terminal module matches an impedance of the memory bus.

17. The computer system as claimed in claim 15, further comprising a decision unit coupled to the terminal module, wherein the decision unit determines whether to turn on the terminal module according to the dynamic select signal and the read signal.

18. The computer system as claimed in claim 17, further comprising a processor coupled between the terminal module and the decision unit for providing the read signal.

19. The computer system as claimed in claim 15, wherein the control chip determines whether to turn on the terminal module according to the read signal when the terminal signal and the dynamic select signal are asserted.

20. The computer system as claimed in claim 19, wherein the terminal module is enabled when the control chip is in a read cycle and the read signal is asserted.

21. The computer system as claimed in claim 19, wherein the terminal module is disabled when the control chip is not in a read cycle and the read signal is deasserted.

22. The computer system as claimed in claim 15, wherein the terminal module is enabled when the terminal signal is asserted and the dynamic select signal is deasserted.

23. The computer system as claimed in claim 15, wherein the terminal module is disabled when the terminal signal is deasserted.

24. The computer system as claimed in claim 15, further comprising a first register for storing the terminal signal and a second register for storing the dynamic select signal.

25. The computer system as claimed in claim 15, wherein the decision unit comprising:
a logic unit outputting an output signal according to logic level of the terminal signal and the read signal; and
a judgment unit determining whether to turn on the terminal module according to the logic levels of the output signal and the dynamic select signal.

26. The computer system as claimed in claim 25, wherein the logic unit is AND gate.

27. The computer system as claimed in claim 25, wherein the judgment unit is a multiplexer.

28. The computer system as claimed in claim 15, wherein the external memory module is a dynamic random access memory (DRAM) or double data rate DRAM (DDR DRAM).

29. The computer system as claimed in claim 15, wherein the control chip is North Bridge chip.

30. A method for controlling a terminal module to match an impedance of a memory bus, the method comprising:
receiving a terminal signal, a dynamic select signal, and a read signal; and
according to the terminal signal, the dynamic select signal and the read signal, selectively turning on the terminal module.

31. The method as claimed in claim 30, wherein the terminal module is enabled according to the reading signal when the terminal signal and the dynamic select signal are asserted.

32. The method as claimed in claim 31, wherein the terminal module is enabled when the terminal module is in a read cycle and the read signal is asserted.

33. The method as claimed in claim 31, wherein the terminal module is disabled when the terminal module is not in a read cycle and the read signal is deasserted.

34. The method as claimed in claim 30, wherein the terminal module is enabled when the terminal signal is asserted and the dynamic select signal is deasserted.

35. The method as claimed in claim 30, wherein the terminal module is disabled when the dynamic select signal is deasserted.

36. The method as claimed in claim 30, wherein the terminal module is an on die terminator (ODT)
